(19) United States
(12) Patent Application Publication
(10) Pub. No.: US 2020/0221664 A1
(43) Pub. Date: Jul. 16, 2020

(54) PET GUARD TO TRANSPORT PETS IN THE BOOT OF MOTORCARS, PARTICULARLY DOGS

(71) Applicant: CAMON S.P.A., Verona (IT)

(72) Inventors: CRISTIAN FRACASSI, BASSANO BRESCIANO (IT); ALVISE MORI, BRESCIA (IT); CESARE CALVI, PARMA (IT)

(73) Assignee: CAMON S.P.A., Verona (IT)

(21) Appl. No.: 15/757,922

(22) PCT Filed: May 23, 2017
(86) PCT No.: PCT/IB2017/053040

§ 371 Date: Mar. 6, 2018

(30) Foreign Application Priority Data
May 23, 2016 (IT) 102016000052891

(51) Int. Cl. A01K 1/02; B60R 21/02

(52) U.S. Cl. CPC A01K 1/0272; B60R 21/026

(57) ABSTRACT

A pet guard to transport pets in the boot (B) of a motorcar (C), comprising a barrier (10) for the reciprocal separation of the boot (B) and the cabin (I) of the motorcar (C) and means (20) to anchor the separation bar (10) to the motorcar (C). The separation bar (10) includes at least one substantially continuous optically transparent plate (11) to allow the driver of the motorcar to see behind the latter therethrough.

### FIELD OF THE INVENTION

The present invention is generally applicable to the technical field of motorcars' accessories, and it particularly relates to a pet guard to transport pets in motorcars, particularly dogs.

### BACKGROUND OF THE INVENTION

It is known that to transport pets, particularly dogs, in the boot of motorcars it is necessary to use a pet guard to prevent the pet from entering in the cabin.

Generally, a pet guard includes a separating barrier and means to anchor it to the motorcar. It is evident that for safety reasons the pet guard has to allow the driver to see in the rear-view mirror what happens behind the motorcar.

A known type of pet guard is a simple net that may be connected in various ways to the motorcar.

It is evident that such a type of pet guard tends to wear out over time and may be more or less simply torn by the pet.

In order to overcome such drawbacks, pet guards have been provided having a separating barrier made of metal bars, possibly telescopic, to adapt to the different dimensions of the boot of the various motorcars brands. In such known pet guards, the hooking means generally consist of a bar with hooks suitable to hook the pet guard to the headrests of the rear seats.

Even such known pet guards are not without drawbacks.

In fact, the separating barrier thereof consists of metal bars telescopically coupled therebetween, thus making such known pet guards very noisy during the drive of the motorcar, since the bars vibrate against one another.

The known pet guards are also difficult to assemble, and they always require the use of screwdrivers, hex keys or specific tools.

Moreover, the metal structure of the separating barrier is quite rigid, therefore it may hurt the pet in case of impact of the latter thereto, for example due to an abrupt braking.

Furthermore, there is enough space between a bar and another one for the animal to introduce the snout therein and to come in contact with the occupants of the motocar. Moreover, such a space favors the passage of dirt, fur or saliva of the pet in the cabin.

Furthermore, they are very bulky, and they occupy a significant part of the boot of the motorcar. In fact, in case all the volume of the latter is required, it is necessary to disassemble the pet guard.

In order to overcome such a drawback, pet guards have been provided wherein the separating barrier is movable between an upper working position and a lower rest position by means of rotation around the fastening bar to the headrest.

In this way, when the boot is not occupied by the dog, it is possible to bring the separating barrier to the rest position, avoiding to disassemble the entire pet guard.

However, the above-mentioned rotating movement further greatly restricts the use of the boot, as well as making it almost unusable if not on motorcars with heavily-sized boot.

### SUMMARY OF THE INVENTION

Object of the present invention is to at least partially overcome the above mentioned drawbacks, by providing a pet guard to transport pets into the boot of a motorcar having high efficiency and relative economy.

Another object of the present invention is to provide a pet guard that allows the transport of pets in the boot safely.

Another object of the present invention is to provide a simple and cheap pet guard to be manufactured.

Another object of the present invention is to provide a pet guard simple to be mounted in the motorcar.

Another object of the present invention is to provide a long-lasting pet guard over time.

Another object of the present invention is to provide a pet guard that minimizes or eliminates vibrations during the drive of the motorcar.

Another object of the present invention is to provide a pet guard that minimizes the consequences of a possible impact of the animal thereto, for example due to an abrupt braking.

Another object of the present invention is to provide a pet guard that prevents the animal to come in contact with the occupants of the motocar.

Another object of the present invention is to provide a pet guard that avoids the passage in the boot of the dirt, fur or saliva of the animal.

Another object of the present invention is to provide a pet guard having a low bulkiness.

Another object of the present invention is to provide a pet guard that allows the use of substantially all the volume of the boot even when it is mounted.

Such objects, as well as others that will be clearer hereinafter, are fulfilled by a pet guard to transport pets in the boot of a motorcar having one or more of the features herein described, shown and/or claimed.

Advantageous embodiments of the invention are described according to the appended claims.

### BRIEF DESCRIPTION OF THE DRAWINGS

Further features and advantages of the invention will be more evident by reading the detailed description of some preferred but non-exclusive embodiments of the invention shown as not limitative example with the help of the annexed drawings, wherein:

FIGS. 1A and 1B are axonometric views of an embodiment of the pet guard 1;

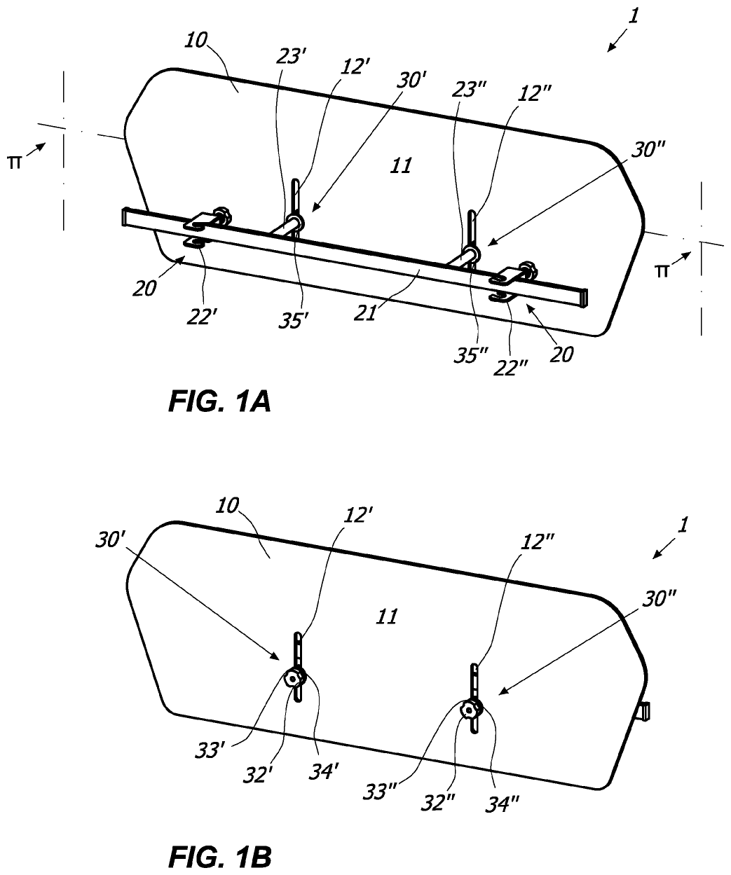

FIGS. 2A and 2B are schematic views of the application of the embodiment of the pet guard 1 of FIGS. 1A and 1B in a car C, wherein the plate 11 is respectively in the working and in the rest position;

FIGS. 3A to 3D are top views of the embodiment of the pet guard 1 of FIGS. 1A and 1B wherein the plate 11 and the support bar 21 are at different distances d, with in FIG. 3E some enlarged details of FIG. 3A.

### DETAILED DESCRIPTION OF SOME PREFERRED EMBODIMENTS

With reference to the above mentioned figures, it is described a pet guard 1 to transport pets in the boot of a motorcar, in particular for dogs in a car C.

Essentially, the pet guard 1 includes a barrier 10 for the reciprocal separation of the boot B and the cabin I of the motorcar C and means 20 to anchor the same barrier to the motorcar C, preferably of the removable type.

Suitably, the anchoring means 20 may include a support structure defined by a bar 21 that may be fastened to the motorcar C, and in particular to the headrests H of the rear seat S by means of hooks 22′, 22″ of a per se known type.

On the other hand, the separation barrier 10 may include or may consist of a substantially continuos optically transparent plate 11 preferably made of polymeric material, such as polycarbonate or PMMA.

In this way, the motorcar driver has no obstruction to the sight and may see behind the motorcar through the plate 11 by means of the rearview mirror.

Therefore, pet transport is accomplished in complete safety.

Since the barrier 10 essentially consists of the sole plate 11, the pet guard 1 is simple and cheap to be manufactured and to be mounted in the motorcar C.

The continuity of the plate 11 makes it totally resistant from the pet, so as the pet guard 1 is long-lasting and maintains the aesthetic appeal thereof substantially unchanged over time.

Moreover, the elasticity of the plate 11 allows the plate thereof to absorb all vibrations induced by the drive of the motorcar, so as the bother for the occupants is minimal if not null.

For the same reason, any possible impact of the animal against the plate 11, for example due to an abrupt braking, may have minimal or no effect.

Furthermore, the continuity of plate 11 may prevent a user inside the cabin I to access the boot B to come in contact with the pet in order to avoid the user's injury thereof, for example, due to an abrupt braking. Such a feature may be particularly relevant when the user is a child.

In this way, the pet guard 1 may be particularly safe both for the pet and for the users inside the cabin I.

The plate 11 may substantially occupy all the width of the boot B of the motorcar C, or, anyway it may be dimensioned so as to prevent the animal from crossing the barrier laterally.

Moreover, the bar 21 may include a pair of elements 23′, 23″ to fasten the plate 11 thereto, preferably in a removable manner, so as the latter completely covers the bar 21.

This prevents the pet from impacting thereto, thus hurting himself.

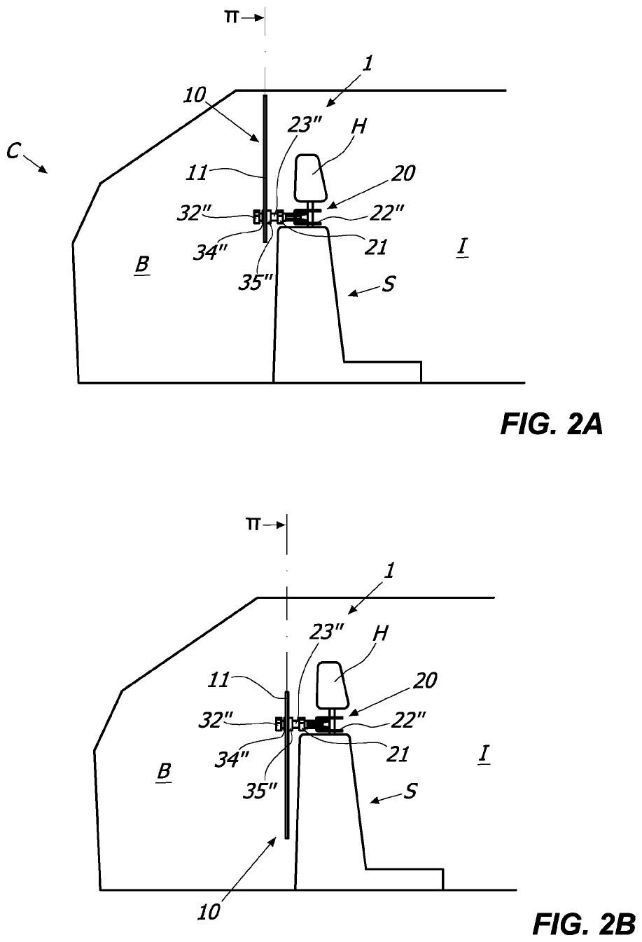

To the object, the plate 11 may include suitable openings wherein the fastening elements 23′, 23″ may be inserted. Suitably, such openings may be defined by elongated slots 12′, 12″, that may act as guiding means for the movement of the plate 11 between an upper working position, shown in FIG. 2A, and a lower rest position, shown in FIG. 2B.

In this way, the elongated slots 12′, 12″ allow the sliding of the plate 11 along the plane π defined thereby. Generally, such a plane π is substantially perpendicular to the driving direction of the motorcar C.

Thanks to such a feature, the bulkiness of the pet guard 1 is minimal, and it allows the maximum volume of the boot B even if in the rest position.

Advantageously, such a sliding may be selectively blocked in any position by means of suitable blocking elements 30′, 30″ engaging with/disengaging from the fastening elements 23′, 23″.

This allows to adjust the height of the working position as desired, for example to leave more or less airing space for the pet.

Suitably, each fastening element 23′, 23″ may include a nut screw 24′, 24″, while each blocking element 30′, 30″ may include a screw 31′, 31″ screwable in/unscrewable from the respective nut screw 24′, 24″ and a knob 32′, 32″ integral with the screw 31′, 31″ thereof having a maneuvering portion 33′, 33″ that may be grasped by the user to screw/unscrew the latter.

Each blocking element 30′, 30″ may also include a first washer 34′, 34″ and a second washer 35′, 35″, both coaxially inserted into the screw 31′, 31″ from opposite sides with respect to the plate 11.

The first washer 34′, 34″ may include an operating portion 36′, 36″ faced to the plate 11 to act against it in response to the screwing of the screw 31′, 31″ into the nut screw 24′, 24″.

The second washer 35′, 35″ may abut against the fastening elements 23′, 23″ to define a corresponding element for the plate 11.

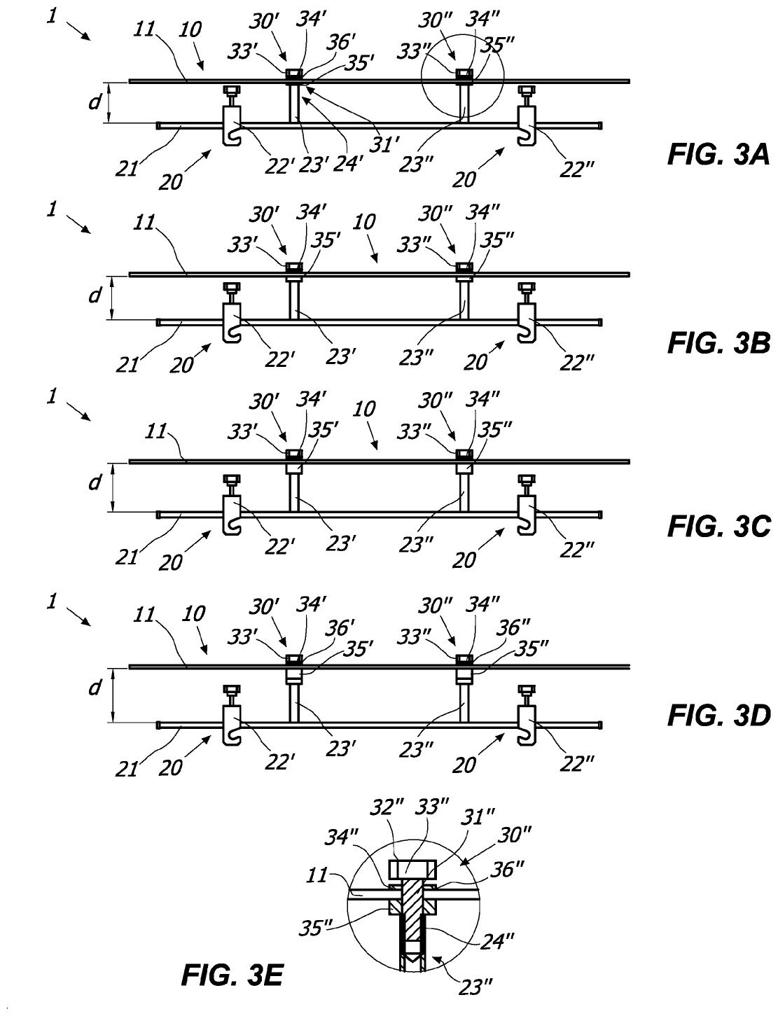

Advantageously, as shown in FIGS. 3A to 3D, for each blocking element 23′, 23″ second washers 35′, 35″ of various size may be provided. This allows to adjust the reciprocal distance d between the plate 11 and the support bar 21 in a quick, easy and cheap way.

Therefore, it is possible to use a single second washer 35′, 35″ of different size, as shown in FIGS. 3A, 3B and 3C, or multiple coupled washers, as shown in FIG. 3D.

With reference to the aforementioned, it is understood that the invention fulfils the intended objects.

The invention is susceptible of numerous modifications and variations, all falling within the inventive concept expressed in the appended claims. All the details may be replaced by other technically equivalent elements and the materials may be different according to requirements without departing from the scope of protection of the invention defined in the appended claims.

1. A pet guard comprising:
a separating barrier for the reciprocal separation of a boot and a cabin of a motorcar;
an anchoring member adapted to anchor the separating barrier to the motorcar;
wherein the separating barrier includes a continuous plate made of an optically transparent polymeric material to allow a driver of the motorcar to see behind the barrier therethrough.

2. Pet guard according to claim 1, wherein the polymeric material is polycarbonate or PMMA.

3. (canceled)

4. Pet guard according to claim 1, wherein the anchoring member is a removable anchoring member.

5. Pet guard according to claim 1, wherein the anchoring member includes a support bar adapted to be removably anchored to the motorcar, the support bar comprising a fastening element, adapted to fasten the plate to the support bar.

6. Pet guard according to claim 5, wherein the fastening element is adapted so as the plate completely covers the support bar, so as in case of accidental impact of a pet lying in the boot of the motorcar against the barrier the pet does not get hurt against the support bar.

7. (canceled)

8. (canceled)

9. (canceled)

10. (canceled)

11. (canceled)

12. (canceled)

13. Pet guard according to claim 5, wherein the fastening element is a removable fastening element.

14. Pet guard according to claim 5, wherein the support bar includes a pair of fastening elements.

15. Pet guard according to claim 14, wherein the fastening elements are removable fastening elements.

16. A pet guard comprising:
a separating barrier for the reciprocal separation of a boot and a cabin of a motorcar, the separating barrier including a continuous plate defining a plane;
a support bar adapted to be removably anchored to the motorcar;
a fastening element adapted to fasten the plate to the support bar;
a guiding system adapted to move the plate between an upper working position and a lower rest position, the guiding system being configured to slidingly move the plate along the plane;
wherein the continuous plate is made of an optically transparent polymeric material to allow a driver of the motorcar to see behind the barrier therethrough.

17. Pet guard according to claim 16, wherein the guiding system includes an elongated slot passing through the plate and defining a sliding direction laying on the plane the fastening element being inserted into the elongated slot.

18. Pet guard according to the claim 16, wherein the support bar includes a pair of fastening elements, the guiding system including a pair of elongated slots passing through the plate and defining a sliding direction lying on the plane, each fastening element being inserted into a respective elongated slot.

19. Pet guard according to claim 16, wherein the guiding system is adapted to selectively blocking the sliding of the plate in any position along the sliding plane.

20. Pet guard according to claim 19, wherein the guiding system includes a blocking element engageable with or disengageable from the fastening element, each blocking element including a command portion adapted to be grasped by a user and an operating portion faced to the plate to act against it in response to the reciprocal engagement of the blocking element and the fastening element.

21. Pet guard according to claim 20, wherein the fastening element includes a screw, the blocking element including a nut screw to be screwed in or unscrewed from the screw and a knob integral to the nut screw that includes the command portion, the blocking element further including a first washer coaxially inserted into the screw that includes the operating portion adapted to abut against a side of the plate, the fastening element further including a second washer also coaxially inserted into the screw adapted to abut against an opposite side of the plate.

22. Pet guard according to claim 21, comprising a plurality of first washers or second washers of different length, so as to allow a user to adjust a reciprocal distance between the plate and the support bar.

23. Pet guard according to claim 19, wherein the support bar includes a pair of fastening elements, the guiding system including a pair of blocking elements-engageable with or disengageable from the pair of fastening elements, each blocking element including a command portion to be grasped by a user and an operating portion faced to the plate to act against it in response to the reciprocal engagement of the pair of blocking elements and the pair of fastening elements.

24. Pet guard according to claim 23, wherein each fastening element includes a screw, each blocking element including a nut screw to be screwed in or unscrewed from the screw and a knob integral to the nut screw that includes the command portion, each blocking element further including a first washer coaxially inserted into the screw that includes the operating portion adapted to abut against a side of the plate, each fastening element further including a second washer also coaxially inserted into the screw adapted to abut against am opposite side of the plate.

25. Pet guard according to claim 24, comprising a plurality of first washers or second washers of different length, so as to allow a user to adjust a reciprocal distance between the plate and the support bar.

26. A pet guard comprising:
a separating barrier for the reciprocal separation of a boot and a cabin of a motorcar, the separating barrier being a continuous plate defining a plane;
a support bar adapted to be removably anchored to the motorcar;
a pair of fastening elements extending from the support bar;
a pair of elongated slots passing through the plate and defining a sliding direction lying on the plane, each fastening element being inserted through a respective elongated slot to slidingly move the plate along the plane;
a pair of blocking elements engageable with or disengageable from the pair of fastening elements, each blocking element including a command portion adapted to be grasped by a user and an operating portion faced to the plate to act against it in response to the reciprocal engagement of the pair of blocking elements and the pair of fastening elements;
wherein the continuous plate is made of an optically transparent polymeric material to allow a driver of the motorcar to see behind the barrier therethrough.
